(19) United States
(12) Patent Application Publication
(10) Pub. No.: US 2017/0345369 A1
(43) Pub. Date: Nov. 30, 2017

(54) PIXEL DRIVING CIRCUIT AND DISPLAY APPRATUS THEREOF

(71) Applicant: HON HAI PRECISION INDUSTRY CO., LTD., New Taipei (TW)

(72) Inventors: CHUNG-WEN LAI, New Taipei (TW); HSIN-HUA LIN, New Taipei (TW)

(21) Appl. No.: 15/604,814

(22) Filed: May 25, 2017

(30) Foreign Application Priority Data
May 26, 2016 (CN) 201610358425.9

(51) Int. Cl. G09G 3/3233; G09G 3/3258

(52) U.S. Cl. CPC G09G 3/3233; G09G 3/3258; G09G 2320/043; G09G 2300/0426; G09G 2330/021; G09G 2310/0289

(57) ABSTRACT

A display apparatus includes a plurality of pixel units. Each pixel unit is driven by a pixel driving circuit. The 4T-2C type pixel driving circuit is consist of the first switch, the second switch, the third switch, the transistor, the capacitor and an organic light emitting diode. In one frame, the pixel driving circuit operates sequentially a reset period, a compensation period, a first writing period, a second writing period, and an illumination period. During the reset period and the compensation period, the first switch turns on, and the transistor receives an offset electric potential from the data line. During the first writing period, the first switch turns on, and the transistor receives a signal electric potential from the data line. During the second writing period and the illumination period, the first switch turns off and electrically disconnects the connection between the transistor and the data line.

### CROSS-REFERENCE TO RELATED APPLICATIONS

This application claims priority to Chinese Patent Application No. 201610358425.9 filed on May 26, 2016, the contents of which are incorporated by reference herein.

### FIELD

The subject matter herein generally relates to a display apparatus with a pixel driving circuit.

### BACKGROUND

An OLED display apparatus includes a plurality of pixels and a plurality of pixel driving circuits. Each of the pixels corresponds to one of the pixel driving circuit and is driven to display images. The driving circuit includes a driving transistor, a switching transistor, a capacitor, and an organic light emitting diode (OLED). The driving transistor controls a driving current flowing in the OLED. The capacitor uniformly holds a gate voltage of the driving transistor during one frame. The switching transistor stores a data voltage in the capacitor. The current flowing in the OLED relates to a lamination of the pixel. A threshold voltage of the driving transistor is adjustable depending on a process deviation, and electrical characteristics of the driving transistor are degraded based on a driving time. For achieving a desired luminance and increasing life span of the OLED display apparatus, thus a compensation circuit of the pixel driving circuit is needed. Therefore, there is room for improvement in the art.

### BRIEF DESCRIPTION OF THE FIGURES

Implementations of the present technology will now be described, by way of example only, with reference to the attached figures.

FIG. 1 is a plan view of an exemplary embodiment of a display apparatus, the display apparatus comprises a driving circuit with a first scan line, a second scan line, a third scan line, and a data line.

FIG. 2 is a circuit diagram of the data scan line, the first scan line, the second scan line, and the third line of FIG. 1.

FIG. 3 is a diagrammatic view of the driving circuit of FIG. 2.

FIG. 4 is a diagrammatic view of the driving circuit of FIG. 2 in a rest period.

FIG. 5 is a diagrammatic view of the driving circuit of FIG. 2 in a compensation period.

FIG. 6 is a diagrammatic view of the driving circuit of FIG. 2 in a first writing period.

FIG. 7 is a diagrammatic view of the driving circuit of FIG. 2 in a second writing period.

FIG. 8 is a diagrammatic view of the driving circuit of FIG. 2 in an illumination period.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

The present disclosure is described in relation to a display apparatus.

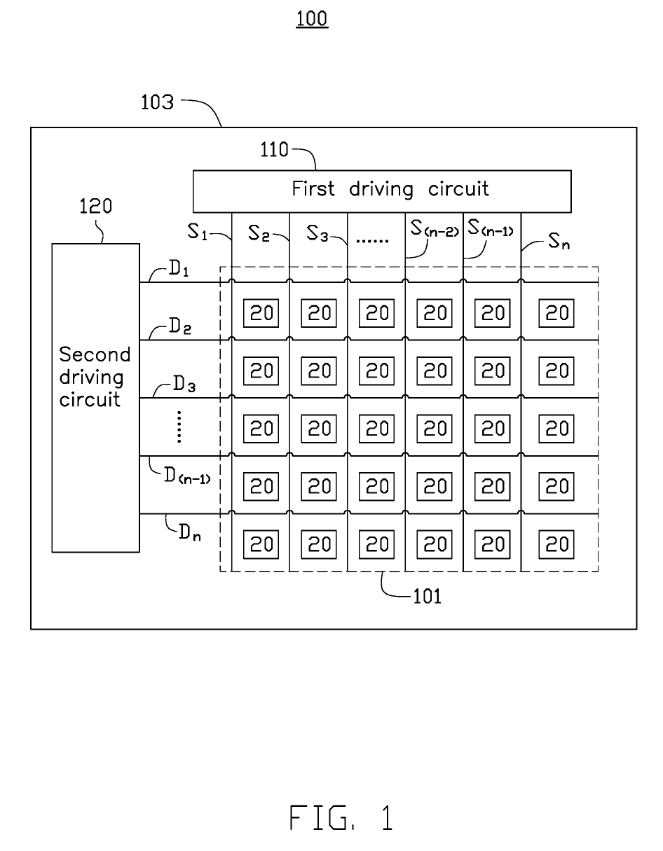

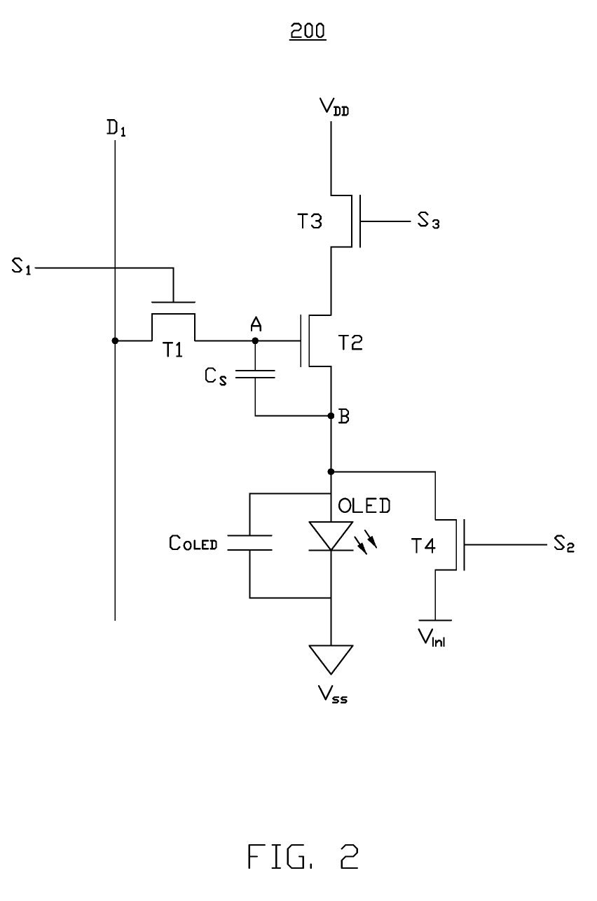

FIG. 1 illustrates an exemplary embodiment of a display apparatus 100. In at least one exemplary embodiment, the display apparatus 100 is for example an organic light emitting diode (OLED) device. The display apparatus 100 defines a display region 101 and a non-display region 103 surrounded with the display region 101. The display apparatus 100 includes a plurality of scan lines S₁-Sₙ extending along a first direction X and a plurality of data lines D₁-Dₘ extending along a second direction Y perpendicular to the first direction X. The scan lines S₁-Sₙ and the data lines D₁-Dₘ cross with each other in a grid, and define a plurality of pixel units 20. The scan lines S₁-Sₙ are insulated from the data lines D₁-Dₘ. The scan lines S₁-Sₙ are electrically connected to a first driving circuit 110, and the data lines D₁-Dₘ are electrically connected to a second driving circuit 120. Main portions of the scan lines S₁-Sₙ and the data lines D₁-Dₘ are located in the display region 101. The first driving circuit 110 and the second driving circuit 120 are located on the non-display region 103. In at least one exemplary embodiment, the first driving circuit 110 is located upon the display region 101, and the second driving circuit 120 is located on a left side of the display region 101. The first driving circuit 110 can be a gate driving circuit, and the second driving circuit 120 can be a source driving circuit configured to provide data signals to each pixel unit 20. Each of the pixel units 20 includes to a pixel driving circuit 200 (as shown in FIG. 2).

FIG. 2 illustrates one pixel unit of the pixel driving circuit 200 of the OLED device. The pixel driving circuit 200 receives signals from a first scan line S₁, a second scan line S₂, a third scan line S₃, a data line D₁. The pixel driving circuit 200 further receives a first direct current (DC) voltage from a power terminal V_{DD}, a second voltage from an initial terminal Vᵢₙᵢ, and a third voltage from a ground terminal Vₛₛ. The pixel driving circuit 200 is a is formed as a 4T-1C type driving circuit, and includes a first switch T1, a transistor T2, a second switch T3, a third switch T4, an organic light emitting diode (OLED), a capacitor Cₛ, and a spastic capacitor C_{oled}. The transistor T2 controls a current following through the OLED. The first switch T1, the second switch T3, and the third switch T4 are respectively controlled by the signal on the first scan line S₁, the second scan line S₂, and the third scan line S₃, for providing different voltages to the transistor T2. The first switch S₁ controls an operation to supply a signal electric potential to the transistor T2. The capacitor Cₛ stores electric potential on the data line D₁ during one frame. The second switch T3 controls a current from the power terminal to be supplied to the OLED. In at least one exemplary embodiment, the first switch T1, the transistor T2, the second switch T3, and the third switch T4 can be a p-type polysilicon thin film transistors. In other embodiments, the first switch T1, the transistor T2, the second switch T3, and the third switch T4 can be p-type amorphous silicon thin film transistors. In at least one exemplary embodiment, the first scan line S₁, the second scan line S₂, and the third scan line S₃ are three adjacent lines of the scan lines S₁-Sₙ, and the data line D1 is one of the data lines D₁-Dₙ. That is, each pixel unit 20 corresponds to or connects to three adjacent scan lines and one date line. In at least one exemplary embodiment, the initial terminal is in a low level voltage state. In at least one exemplary embodiment, the first switch T1, the transistor T2, the second switch T3, and the third switch T4 are all N-type Metal Oxide Semiconductor (NMOS) transistors.

A gate electrode of the first switch T1 is electrically connected to the first scan line S₁, a source electrode of the first switch T1 is electrically connected to the data line D₁, and a drain electrode of the first switch T1 is electrically connected to a gate electrode of the transistor T2. A first node A is electrically connected between the drain electrode of the first switch T1 and the gate electrode of the transistor T2. A source electrode of the transistor T2 is electrically connected to a drain electrode of the second switch T3, and a drain electrode of the transistor T2 is electrically connected to an anode of the OLED. A second node B is electrically connected between the drain electrode of the transistor T2 and the anode of the OLED. A cathode of the OLED is electrically connected to the ground terminal Vₛₛ. A gate electrode of the second switch T3 is electrically connected to the third scan line S₃, and a source electrode of the second switch T3 is electrically connected to the power terminal V_{DD}. A gate electrode of the third switch T4 is electrically connected to the second scan line S₂, a source electrode of the third switch T4 is electrically connected to the second node B, and a drain electrode of the third switch T4 is electrically connected to the initial terminal Vᵢₙᵢ. Two opposite terminals of the capacitor Cₛ are electrically connected to the gate electrode of the second transistor T2 and the drain electrode of the second transistor T2 respectively. Two opposite terminals of the parasitic capacitor C_{oled} are electrically connected between the anode of the OLED and the cathode of the OLED respectively. In at least one exemplary embodiment, signals provided on the first scan line S₁, the second scan line S₂, and the third scan line S₃ are switched between a low level voltage and a high level voltage, and the signal provided by the data line D1 is switched between an offset electric potential Vofs and a signal electric potential V_{sig}. In at least one exemplary embodiment, the power terminal V_{DD} supplies a specified voltage, and connects with all the pixel units 20 respectively. The specified voltage is a high level voltage, and is capable of providing a current to the OLED during the switch T3 turns on.

Furthermore, the transistor T2 is a driving thin film transistor, employed to drive the organic light emitting diode to emit light.

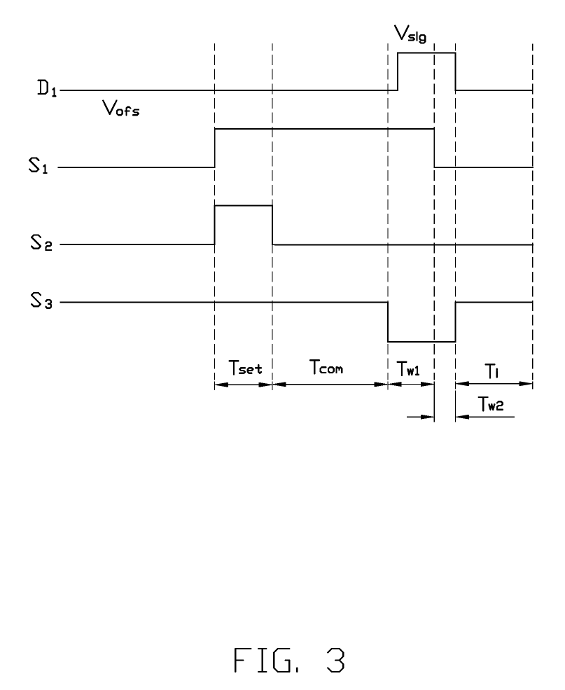

FIG. 3 illustrates a timing diagram of a scanning signal of the first scan line S₁, a scanning signal of the second scan line S₂, a scanning signal of the third scan line S₃, the data signal provided on the data line D₁ of the pixel driving circuit 200. The pixel driving circuit 200 operates sequentially within one frame time comprising a reset period Tₛₑₜ, a compensation period T_{com}, a first writing period T_{w1}, a second writing period T_{w2}, and an illumination period Tᵢ.

During the reset period Tₛₑₜ, the pixel driving circuit 200 is reset and the OLED stops emitting light. During the compensation period T_{com}, the pixel driving circuit 200 charges the first capacitor Cₛ which is used to compensate for a threshold voltage degradation of the transistor T2 based on the voltage stored on the first capacitor Cₛ. During the first writing period T_{w1}, the pixel driving circuit 200 transmits data signal to the gate of the transistor T2. During the second writing period T_{w2}, the pixel driving circuit 200 remains the voltage of the second node B. During the illumination period Tᵢ, the pixel driving circuit 200 provides a current to the OLED for emitting light by sequentially passing through the third switch T3 and the transistor T2.

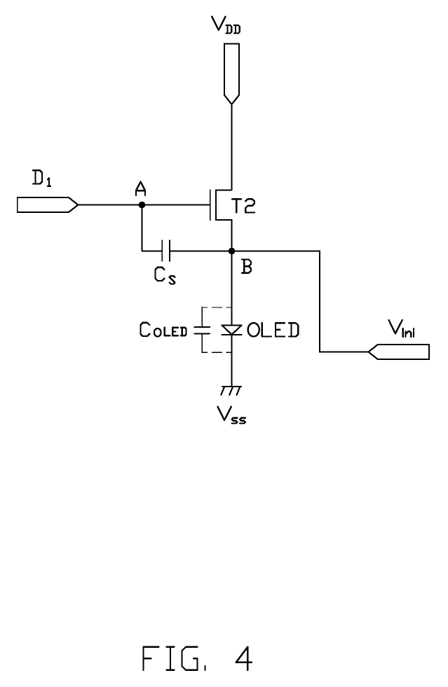

FIG. 4 illustrates the pixel driving circuit 200 in the reset period Tₛₑₜ. During the reset period Tₛₑₜ, the first scan line S₁, the second scan line S₂, and the third scan line S₃ are in the high level voltage, and the voltage of the data line D₁ is the offset electric potential V_{ofs}. The first switch T1, the transistor T2, the second switch T3, and the fourth switch T4 are switched on. The voltage of the second node B is equal to the voltage of the initial terminal Vᵢₙᵢ. Thus, the voltages of the gate electrode and the source electrode of the transistor T2 are being reset. When the voltage of the initial terminal Vᵢₙᵢ is less than the voltage of the ground terminal Vss, the voltage difference between the anode and the cathode of the OLED is less than a forward voltage of the OLED, the OLED is in a non-luminance state.

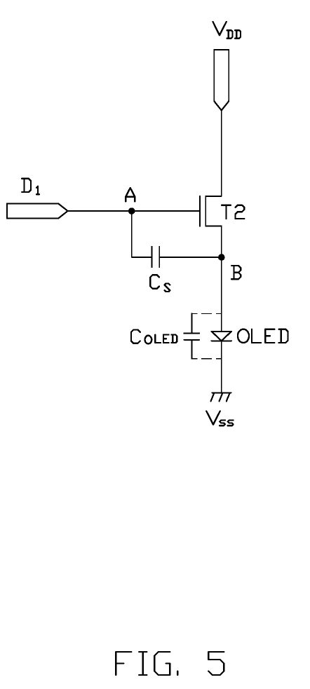

FIG. 5 illustrates the pixel driving circuit 200 in the compensation period T_{com}. During the compensation period T_{com}, the first scan line S₁ and the third scan line S₃ are in the high level voltage, the second scan line S₂ is in a low level voltage, and the voltage of the data line D₁ is the offset electric potential V_{ofs}. The first switch T1, the transistor T2, and the second switch T3 remains being switched on. The capacitor Cₛ is charged by a current flowing through the second switch T3. Thus, the threshold voltage degradation of the transistor T2 is compensated by the voltage stored on the first capacitor Cₛ. The third switch T4 is turned off. The voltage of the second node B is equal to a difference between the offset electric potential V_{ofs} and a threshold voltage of the transistor T2, the voltage difference between the anode and the cathode of the OLED is less than the forward voltage of the OLED, which causes the OLED to maintain in the non-luminance state.

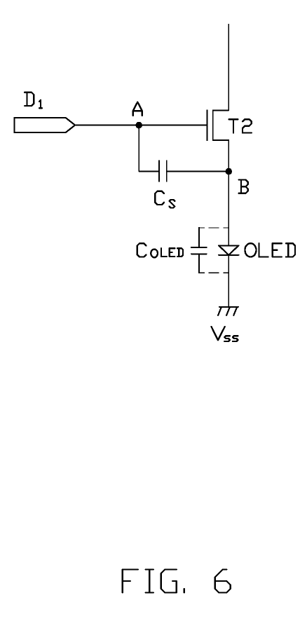

FIG. 6 illustrates the pixel driving circuit 200 in the first writing period T_{w1}. During the first writing period T_{w1}, the first scan line S₁ is in the high level voltage, the second scan line S₂ and the third scan line S₃ are in a low level voltage, and the voltage of the data line D₁ is the signal electric potential V_{sig}. The first switch T1 and the transistor T2 remains being turned on, and the signal electric potential V_{sig} is provided to the gate electrode of the transistor T2 by passing through the first switch T1. The second switch T3 and the third switch T4 are turned off. The capacitor C_{OLED} is charged by the difference of the signal electric potential V_{sig} and the offset electric potential V_{ofs}, and thus the voltage of the second node B rises. The voltage of the second node B is a sum of the voltage at the compensation period and the voltage risen by the charged capacitor C_{OLED}. The voltage of the second node B is calculated by the following formula:

V_{B}=V_{ofs}−Vₜₕ+[(V_{sig}−V_{ofs})Cₛ/(Cₛ+C_{OLED})] 1)

Vₜₕ represents the threshold voltage of the transistor T2.

The voltage difference between the anode and the cathode of the OLED is less than the forward voltage of the OLED, which cause the OLED to maintain in the non-luminance state.

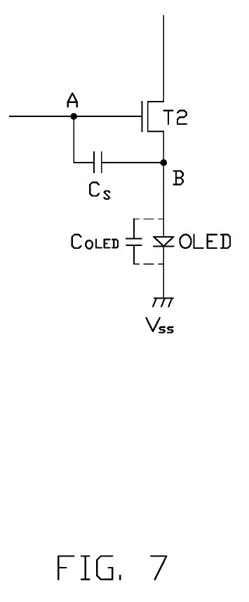

FIG. 7 illustrates the pixel driving circuit 200 in the second writing period T_{w2}. During the second writing period T_{w2}, the first scan line S₁, the second scan line S₂ and the third scan line S₃ are in the low level voltage, and the voltage of the data line D₁ is the signal electric potential V_{sig}. The first switch T1, the second switch T2, and the third switch T3 are turned off. The voltage of the second node B remains, the voltage difference between the anode and the cathode of the OLED is less than the forward voltage of the OLED, which cause the OLED to maintain in the non-luminance state.

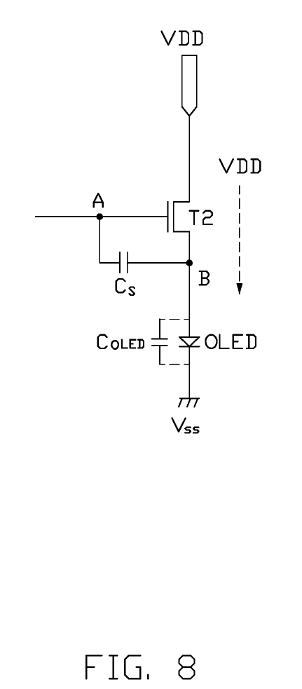

FIG. 8 illustrates the pixel driving circuit 200 in the illumination period Tᵢ. During the illumination period Tᵢ, the first scan line S₁ and the second scan line S₂ are in the low level voltage, the third scan line S₃ is in the high level voltage, and the voltage of the data line D₁ is the offset electric potential V_{ofs}. The first switch T1 and the third switch T4 remains being turned off. The transistor T2 and the second transistor T3 are turned on, and a current is provided to the OLED from the power terminal V_{DD}. The voltage of the first node A is equal to a sum of the signal electric potential V_{sig} and a raised voltage provided by the power terminal V_{DD}. The voltage of the second node B is a sum of the voltage at the second writing period and the voltage risen by the power terminal V_{DD}. The voltage of the second node B is calculated by the following formula:

V_{B}=V_{ofs}−Vₜₕ+[(V_{sig}−V_{ofs})Cₛ/(Cₛ+C_{OLED})]+V_{f} 2)

V_{f} represents a rising voltage provided by the power terminal V_{DD}.

The voltage of the second node B remains. The voltage difference between the anode and the cathode of the OLED is greater than the forward voltage of the OLED, the OLED is switched into a luminance state.

In the structure of the pixel driving circuit 200 under the driving sequence, the number of the transistors in the pixel driving circuit 200 is reduced, thereby increasing reducing an aperture ratio to achieve a high performance. Due to the first direct voltage provided by the power terminal V_{DD}, the power terminal V_{DD} connects with all the pixel unit 20 by a same power line instead of extending a plurality of independent lines to connected with the pixel units 20 respectively, a number of lines extended from the power terminal to be connected to each pixel unit 20 is reduced, thus a resistance of the lines connected to the power terminal is decreased for saving power. Due to the second switch T3, the threshold voltage degradation of the transistor T2 is compensated for ensuring the writing operation in the writing period. Thereby, a performance of the display apparatus 100 is improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A display apparatus comprising:
a plurality of scan lines;
a plurality of data lines configured to intersect with the scan lines in a grid to define a plurality of pixel units, and insulate from the scan lines;
a plurality of pixel driving circuits corresponding to the pixel units in a one-to-one relationship, and configured to drive the corresponding pixel units;
wherein each of the pixel driving circuit comprises a first switch, a second switch, a third switch, a transistor, a capacitor, and an organic light emitting diode (OLED); the transistor controls a current following in the OLED; the capacitor stores electric potential on a data line during one frame; the first switch controls an operation to supply an electric potential to the transistor; the pixel driving circuit operates sequentially within one frame time comprising a reset period, a compensation period, a first writing period, a second writing period, and an illumination period; during the reset period and the compensation period, the first switch being turned on establishes an electrical connection between the transistor and the data line, and the transistor receives an offset electric potential from the data line, during the first writing period, the first switch being turned on establishes the electrical connection between the transistor and the data line, the transistor receives a signal electric potential from the data line; during the second writing period and the illumination period, the first switch turns off and electrically disconnects the connection between the transistor and the data line.

2. The display apparatus of claim 1, wherein each pixel driving circuit is formed as a 4T-1C type driving circuit, which is consist of the first switch, the second switch, the third switch, the transistor, the capacitor, and the OLED.

3. The display apparatus of claim 1, wherein the pixel driving circuit further is connected to a first scan line, a second scan line, and a third scan line; a gate electrode of the first switch is electrically connected to the first scan line, a drain electrode of the first switch is electrically connected to the data line, and a drain electrode of the first switch is electrically connected to a gate electrode of the transistor; a source electrode of the transistor is electrically connected to a drain electrode of the second switch, and a drain electrode of the transistor is electrically connected to an anode of the OLED; a cathode of the OLED is electrically connected to a ground terminal; a gate electrode of the second switch is electrically connected to the third scan line, and a source electrode of the second switch is electrically connected to a power terminal; a gate electrode of the third switch is electrically connected to the second scan line, a source electrode of the second switch is electrically connected between the drain electrode of the transistor and the anode of the OLED, and a drain electrode of the third switch is electrically connected to an initial terminal; two opposite terminals of the capacitor are electrically connected to the gate electrode and the source electrode of the second transistor respectively.

4. The display apparatus of claim 1, wherein the signal electric potential is greater than the offset electric potential; the first transistor turns off based on offset electric potential, and turns on based on the signal electric potential.

5. The display apparatus of claim 3, wherein during the reset period, the first scan line, the second scan line, and the third scan line are in a high level voltage, and the voltage of the data line is the offset electric potential; the first switch, the transistor, the second switch, and the fourth switch are turned on, a voltage difference between the anode and the cathode of the OLED is less than a forward voltage of the OLED, and the OLED is in a non-luminance state.

6. The display apparatus of claim 3, wherein during the compensation period, first scan line and the third scan line are in a high level voltage, the second scan line is in a low level voltage, and the voltage of the data line is the offset electric potential; the capacitor is charged by a current flowing through the second switch.

7. The display apparatus of claim 3, wherein during the illumination period, the first scan line and the second scan line are in a low level voltage, the third scan line is in a high level voltage, and the voltage of the data line is the offset electric potential; the voltage difference between the anode and the cathode of the OLED is larger than a forward voltage of the OLED, the switched into a luminance state.

8. The display apparatus of claim 3, wherein during the first writing period, the first scan line is in a high level voltage, the second scan line and the third scan line are in a low level voltage, and the voltage of the data line is the signal electric potential; the first switch and the transistor remains being turned on, and the signal electric potential is provided to the gate electrode of the transistor by passing through the first switch; the capacitor is charged by the signal electric potential; the second switch and the third switch are turned off, the voltage difference between the anode and the cathode of the OLED is less than the forward voltage of the OLED, the OLED is in a non-luminance state.

9. The display apparatus of claim 3, wherein during the second writing period, the first scan line, the second scan line and the third scan line are in a low level voltage, and the voltage of the data line is the signal electric potential; the first switch, the second switch, and the third switch are turned off, the voltage of the anode of the OLED remains to be equal to the voltage of the anode of the OLED in the first writing period.

10. The display apparatus of claim 1, wherein the first switch, the transistor, the second switch, and the third switch are p-type thin film transistors.

11. A pixel driving circuit for driving a pixel unit, the pixel driving circuit receiving signals from a first scan line, a second scan line, a third scan line, and a data line, and further receiving a first voltage, a second voltage, and a third voltage; the pixel driving circuit comprising:
a first switch;
a second switch;
a third switch;
a transistor;
a capacitor; and
an organic light emitting diode (OLED) configured to emit light;
wherein the transistor controls a current following in the OLED, the capacitor stores electric potential from the data line during one frame; the first switch controls an operation to supply an electric potential to the transistor; the second switch always receives a direct current from a power terminal; a gate electrode of the first switch is electrically connected to the first scan line, a drain electrode of the first switch is electrically connected to the data line, and a drain electrode of the first switch is electrically connected to a gate electrode of the transistor; a source electrode of the transistor is electrically connected to a drain electrode of the second switch, and a drain electrode of the transistor is electrically connected to an anode of the OLED; a cathode of the OLED is electrically connected to a ground terminal; a gate electrode of the second switch is electrically connected to the third scan line, and a source electrode of the second switch is electrically connected to the power terminal; a gate electrode of the third switch is electrically connected to the second scan line, a source electrode of the second switch is electrically connected between the drain electrode of the transistor and the anode of the OLED, and a drain electrode of the third switch is electrically connected to an initial terminal; two opposite terminals of the capacitor are electrically connected to the gate electrode and the source electrode of the second transistor respectively.

12. The display apparatus of claim 11, wherein the pixel driving circuit operates sequentially within one frame time comprising a reset period, a compensation period, a first writing period, a second writing period, and an illumination period; during the first writing period, the first switch turns on, the second switch and the third switch turn off, the pixel driving circuit transmits data signal to the transistor; during the second writing period, the first switch, the second switch, and the third switch turn off, the pixel driving circuit remains a voltage of the anode of the OLED which is equal to a voltage of the anode of the OLED in the first writing period.

13. The display apparatus of claim 11, wherein during the reset period, the first scan line, the second scan line, and the third scan line are in a high level voltage, and the voltage of the data line is an offset electric potential for controlling the first switch to be turned on; the first switch, the transistor, the second switch, and the fourth switch are turned on; a voltage difference between the anode and the cathode of the OLED is less than a forward voltage of the OLED, the OLED is in a non-luminance state.

14. The pixel driving circuit of claim 11, wherein during the compensation period, first scan line and the third scan line are in a high level voltage, the second scan line is in a low level voltage, and the voltage of the data line is an offset electric potential for controlling the first switch to be turned on; the capacitor is charged by a current flowing through the second switch.

15. The pixel driving circuit of claim 11, wherein during the illumination period, the first scan line and the second scan line are in a low level voltage, the third scan line is in a high level voltage, and the voltage of the data line is an offset electric potential for controlling the first switch to be turned on; the voltage difference between the anode and the cathode of the OLED is larger than a forward voltage of the OLED, the switched into a luminance state.

16. The pixel driving circuit of claim 11, wherein during the first writing period, the first scan line is in a high level voltage, the second scan line and the third scan line are in a low level voltage, and the voltage of the data line is a signal electric potential for controlling the first switch to be turned off; the first switch and the transistor remains being turned on, and the signal electric potential is provided to the gate electrode of the transistor by passing through the first switch; the capacitor is charged by the signal electric potential; the second switch and the third switch are turned off, the voltage difference between the anode and the cathode of the OLED is less than the forward voltage of the OLED, the OLED is in a non-luminance state.

17. The pixel driving circuit of claim 11, wherein during the second writing period, the first scan line, the second scan line and the third scan line are in a low level voltage, and the voltage of the data line is the signal electric potential; the first switch, the second switch, and the third switch are turned off, the voltage of the anode of the OLED remains to be equal to the voltage of the anode of the OLED in the first writing period.

18. The pixel driving circuit of claim 11, wherein the first switch, the transistor, the second switch, and the third switch are p-type thin film transistors.
